(19) United States
(12) Patent Application Publication
(10) Pub. No.: US 2025/0147977 A1
(43) Pub. Date: May 8, 2025

(54) OPERATION MANAGEMENT APPARATUS, SYSTEM, AND METHOD, AND COMPUTER-READABLE MEDIUM

(71) Applicant: NEC Corporation, Minato-ku, Tokyo (JP)

(72) Inventor: Toru WAKITANI, Tokyo (JP)

(73) Assignee: NEC Corporation, Minato-ku, Tokyo (JP)

(21) Appl. No.: 18/837,912

(22) PCT Filed: Feb. 28, 2022
(86) PCT No.: PCT/JP2022/008427

§ 371 Date: Aug. 13, 2024

(51) Int. Cl. G06F 16/25

(52) U.S. Cl. CPC G06F 16/254

(57) ABSTRACT

An operation management apparatus includes an extraction unit that extracts data for each item from a collection file based on format information of the collection file collected from a component of an information system and definition information of a delimiter character between items defined by the component, a storage unit that stores the extracted data and the item in association with each other in a collected data table, and a comparison unit that compares data associated with an item common in an expected value table that stores an expected value of each item in the collection file and the collected data table, and outputs a comparison result.

### TECHNICAL FIELD

The present invention relates to an operation management apparatus, a system, a method, and a program.

### BACKGROUND ART

In recent years, with enlargement and complication of information systems, types of collection target data to be collected from the information systems are diversified. Here, the information system includes various components such as hardware such as a computer (server), a communication device (network device), and a storage device, and software such as an operating system (OS), middleware, or an application. Then, an operator of the information system collects setting contents of the network, hardware, and software of each component as a file, analyzes the collection file, and performs setting confirmation, failure monitoring, and the like.

Patent Literature 1 discloses a technique related to a management system of environment definition information in a large-scale computing system. The management system stores a master file of a system setting file to be distributed and applied to each computer of the large-scale computing system in a storage unit. In addition, the management system generates form data in a predetermined unified format based on a given environment definition parameter value, and stores the form data in the storage unit. Then, the management system collects an environment definition file applied to each computer, and checks the syntax of the file, the appropriateness of the setting parameter value, and the difference from the master file.

Patent Literature 2 discloses a technique related to a master file difference automatic output apparatus. The apparatus refers to a master configuration comparison table file in which a correspondence relationship of items between new and old master files is defined in advance, and extracts a difference in a record unit between the old master and the new master. Then, the apparatus compares the item value for each item in each record using the record unit difference file, and displays only the item whose item value has been updated.

### CITATION LIST

### Patent Literature

Patent Literature 1: Japanese Unexamined Patent Application Publication No. 2004-046445

Patent Literature 2: Japanese Unexamined Patent Application Publication No. 2014-099004

### SUMMARY OF INVENTION

### Technical Problem

In the techniques according to Patent Literatures 1 and 2, each file to be compared is analyzed by each analysis logic, and difference comparison on a file basis is performed. However, there are a wide variety of setting files for each component in the information system, and it is necessary to consider not only a difference in file format but also a difference in description rule for each component. Therefore, various analysis processing modules are required, and in particular, there is a problem that implementation of the item value extraction processing becomes complicated.

In view of the above-described problems, an object of the present disclosure is to provide an operation management apparatus, a system, a method, and a program for efficiently extracting various setting values of an information system and supporting verification of validity of the setting values.

### Solution to Problem

An operation management apparatus according to a first aspect of the present disclosure includes:
an extraction means for extracting data for each item from a collection file based on format information of the collection file collected from a component of an information system and definition information of a delimiter character between items defined by the component;
a storage means for storing the extracted data and the item in association with each other in a collected data table; and
a comparison means for comparing data associated with a common item in an expected value table storing an expected value of each item in the collection file and the collected data table and outputting a comparison result.

An operation management system according to a second aspect of the present disclosure includes:
a collection apparatus configured to collect a collection file from a component of an information system; and
an operation management apparatus connected to the collection apparatus,
in which the operation management apparatus includes
an extraction means for extracting data for each item from the collection file collected by the collection apparatus based on format information of the collection file and definition information of a delimiter character between items defined by the component,
a storage means for storing the extracted data and the item in association with each other in a collected data table, and
a comparison means for comparing data associated with a common item in an expected value table storing an expected value of each item in the collection file and the collected data table and outputting a comparison result.

An operation management method performed by a computer according to a third aspect of the present disclosure includes:
extracting data for each item from a collection file based on format information of the collection file collected from a component of an information system and definition information of a delimiter character between items defined by the component;
storing the extracted data and the item in association with each other in a collected data table; and
comparing data associated with a common item in an expected value table storing an expected value of each item in the collection file and the collected data table and outputting a comparison result.

An operation management program according to a fourth aspect of the present disclosure causes a computer to execute:
extraction processing of extracting data for each item from a collection file based on format information of the collection file collected from a component of an information system and definition information of a delimiter character between items defined by the component;
storage processing of storing the extracted data and the item in association with each other in a collected data table; and
comparison processing of comparing data associated with a common item in an expected value table storing an expected value of each item in the collection file and the collected data table and outputting a comparison result.

### Advantageous Effects of Invention

According to the present disclosure, it is possible to provide an operation management apparatus, a system, a method, and a program for efficiently extracting various setting values of an information system and supporting verification of validity of the setting values.

### BRIEF DESCRIPTION OF DRAWINGS

FIG. 1 is a block diagram illustrating a configuration of an operation management apparatus according to a first example embodiment.

FIG. 2 is a flowchart illustrating a flow of an operation management method according to the first example embodiment.

FIG. 3 is a block diagram illustrating an overall configuration including an operation management system according to a second example embodiment and an information system to be managed.

FIG. 4 is a diagram illustrating an example of a collection file (CSV) according to the second example embodiment.

FIG. 5 is a diagram illustrating an example of a collection file (XML) according to the second example embodiment.

FIG. 6 is a block diagram illustrating a configuration of an operation management apparatus according to the second example embodiment.

FIG. 7 is a diagram illustrating an example of collection file definition information according to the second example embodiment.

FIG. 8 is a diagram illustrating an example of delimiter definition information according to the second example embodiment.

FIG. 9 is a diagram illustrating an example of an expected value table according to the second example embodiment.

FIG. 10 is a diagram illustrating an example of a collected data table according to the second example embodiment.

FIG. 11 is a flowchart illustrating a flow of expected value registration processing according to the second example embodiment.

FIG. 12 is a flowchart illustrating a flow of collected data registration processing according to the second example embodiment.

FIG. 13 is a flowchart illustrating a flow of comparison processing according to the second example embodiment.

FIG. 14 is a diagram illustrating an example of comparison result information of all items according to the second example embodiment.

FIG. 15 is a block diagram illustrating a configuration of an operation management apparatus according to a third example embodiment.

FIG. 16 is a diagram illustrating an example of comparison definition information according to the third example embodiment.

FIG. 17 is a flowchart illustrating a flow of comparison processing according to the third example embodiment.

FIG. 18 is a diagram illustrating an example of comparison result information of a designated item according to the third example embodiment.

FIG. 19 is a block diagram illustrating a configuration of an operation management apparatus according to a fourth example embodiment.

FIG. 20 is a flowchart illustrating a flow of comparison processing according to the fourth example embodiment.

### EXAMPLE EMBODIMENT

Hereinafter, example embodiments of the present disclosure will be described in detail with reference to the drawings. In the drawings, the same or corresponding elements are denoted by the same reference numerals, and redundant description is omitted as necessary for clarity of description.

### First Example Embodiment

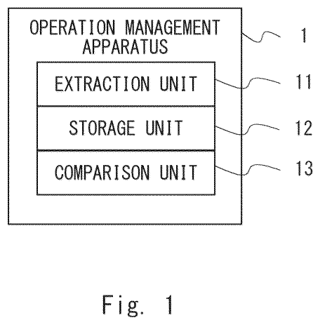

FIG. 1 is a block diagram illustrating a configuration of an operation management apparatus 1 according to a first example embodiment. The operation management apparatus 1 is an information processing apparatus for performing operation management of an information system. In particular, the operation management apparatus 1 compares the setting value in each setting item included in a collection file collected from the component of the information system with the expected value of the setting item. Here, the components refer to hardware and software constituting the information system. The hardware includes, for example, a computer (server), a communication device (network device), a storage device, and the like. In addition, the software includes an OS, middleware, an application, or the like. Note that the components of the information system are not limited thereto.

The operation management apparatus 1 includes an extraction unit 11, a storage unit 12, and a comparison unit 13. The extraction unit 11 extracts data for each item from the collection file based on format information of the collection file collected from a component of the information system and definition information of a delimiter character between items defined by the component. Here, the format information is information defining the format of the file. For example, in the case of an extensible markup language (XML) file, the format information is an XML schema, a document type definition (DTD), or the like, and in the case of a comma-separated values (CSV), the format information is set as a record by a line feed character and data is separated by a comma, or the like.

The storage unit 12 stores the extracted data and items in association with each other in the collected data table. The comparison unit 13 compares data associated with a common item in the expected value table and the collected data table, and outputs a comparison result.

Here, the expected value table is a table in which the expected value of each item in the collection file is stored. In addition, the format information, the definition information of the delimiter character between items, the expected value table, and the collected data table described above are information stored in a storage device inside the operation management apparatus 1 or an external storage device connected to the operation management apparatus 1.

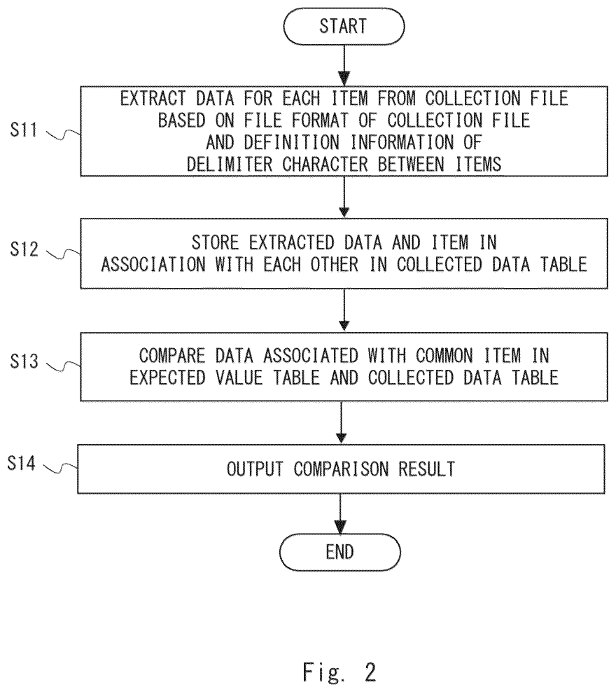

FIG. 2 is a flowchart illustrating a flow of the operation management method according to the first example embodiment. First, the extraction unit 11 extracts data for each item from the collection file based on the format information of the collection file and the definition information of the delimiter character between the items (S11). Here, it is assumed that the collection file is collected in advance from the components of the information system by the operation management apparatus 1 or another computer. In addition, it is assumed that the delimiter character between items is a character defined by the components. Therefore, for example, when the collection file is a CSV file, the delimiter character between the items is a character other than the line feed character and the comma. Meanwhile, when the collection file is an XML file, the delimiter character between the items may include a comma.

Next, the storage unit 12 stores the extracted data and items in association with each other in the collected data table (S12). Then, the comparison unit 13 compares the data associated with the common item in the expected value table and the collected data table (S13). Thereafter, the comparison unit 13 outputs a comparison result (S14).

As described above, the operation management apparatus 1 according to the present example embodiment not only analyzes the collection file according to the file format, but also analyzes the collection file using the delimiter character between the items defined by the components. Therefore, data for each item can be appropriately extracted from collection files of various formats. Since both the expected value table and the collected data table are associated with items and data (expected value or collected data), comparison between the tables is easy. Therefore, it is possible to efficiently extract various setting values of the information system and support verification of validity of the setting values.

Note that the operation management apparatus 1 includes a processor, a memory, and a storage device as components (not illustrated). In addition, the storage device stores a computer program in which the processing of the operation management method according to the present example embodiment is implemented. Then, the processor reads a computer program or the like from the storage device into the memory, and executes the computer program. As a result, the processor implements the functions of the extraction unit 11, the storage unit 12, and the comparison unit 13.

Alternatively, each component of the operation management apparatus 1 may be realized by dedicated hardware. In addition, some or all of the components of each device may be realized by general-purpose or dedicated circuitry, a processor, or the like, or a combination thereof. These may be configured by a single chip or may be configured by a plurality of chips connected via a bus. Some or all of the components of each device may be realized by a combination of the above-described circuitry or the like and a program. Furthermore, as the processor, a central processing unit (CPU), a graphics processing unit (GPU), a field-programmable gate array (FPGA), a quantum processor (quantum computer control chip), or the like can be used.

### Second Example Embodiment

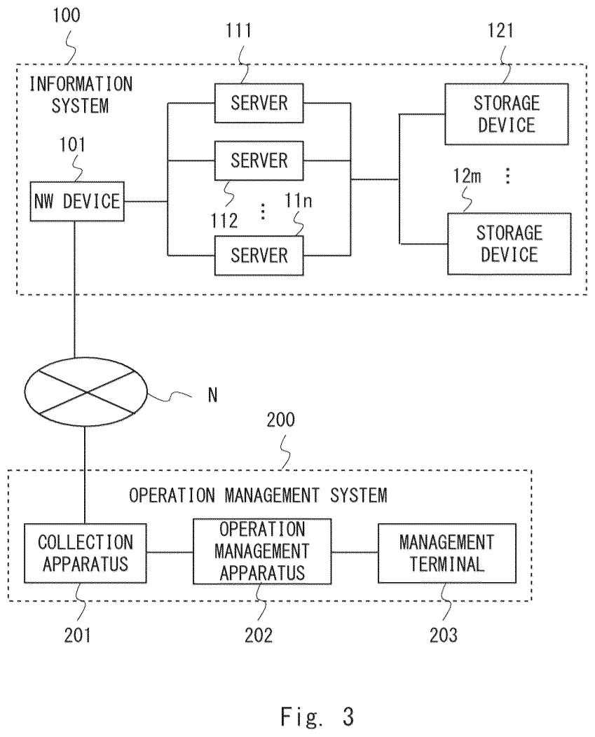

A second example embodiment is a specific example of the first example embodiment described above. FIG. 3 is a block diagram illustrating an overall configuration including an operation management system 200 according to the second example embodiment and an information system 100 to be managed. The information system 100 and the operation management system 200 are connected via a network N. The network N is a communication network including a wireless communication line network, a mobile phone line network, and the like. The network N may include the Internet. The communication network may be of any type of communication protocol.

The information system 100 includes a plurality of components. For example, the information system 100 includes a network (NW) device 101, servers 111, 112, . . . 11n (n is a natural number of 1 or more.), and storage devices 121, . . . 12 m (m is a natural number of 1 or more.). In this example, it is indicated that the NW device 101 is connected to each of the network N and the servers 111 to 11n, and each of the servers 111 to 11n is connected to each of the storage devices 121 to 12 m. However, the hardware configuration and the connection relationship of the information system 100 are not limited thereto.

In addition, each of the NW device 101, the server 111 to 11n, and the storage device 121 to 12 m may be able to output a setting value in hardware, firmware, an OS, middleware, an application, or the like as a setting file by a predetermined command. Alternatively, each of the NW device 101, the servers 111 to 11n, and the storage devices 121 to 12 m may be able to output a log such as software as a log file by a predetermined command. Alternatively, each of the NW device 101, the servers 111 to 11n, and the storage devices 121 to 12 m may output the setting file or the log file to a built-in storage area or an external storage device. The setting file or the log file is a file in which a construction value (attribute value, parameter value) is recorded for each of a plurality of items (or attributes), and is an example of a collection file.

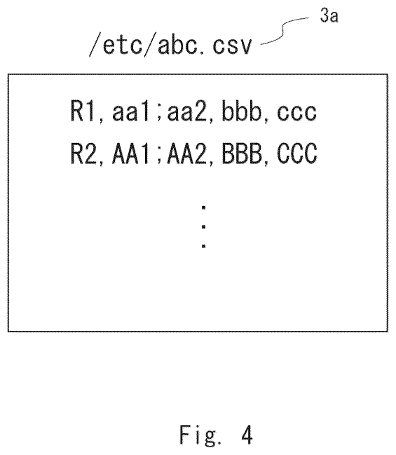

FIG. 4 is a diagram illustrating an example of the collection file 3a (CSV) according to the second example embodiment. The collection file 3a is a file in CSV format in which each data record is separated by the line feed character, and each item value in the data record is separated by a comma character “,”. Further, in the collection file 3a, it is assumed that a collection source component includes a plurality of item values in a character string between the comma character and the comma character with a unique specification and is defined so that items are separated by a semicolon character “;”. For example, a record in the first line of the collection file 3a is a character string “R1, aa1; aa2, bbb, ccc”, and indicates that five item values of “R1”, “aa1”, “aa2”, “bbb”, and “ccc” are included by a comma character and a semicolon character.

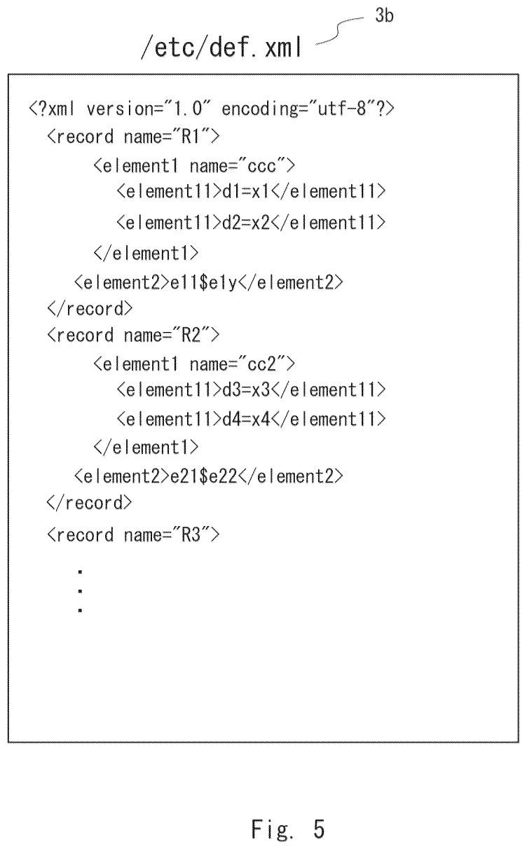

FIG. 5 is a diagram illustrating an example of the collection file 3b (XML) according to the second example embodiment. The collection file 3b is a file in XML format in which each data record, an item name and an item value therein are described according to format information such as XML tag definition. In this case, for example, the XML format is defined in the format information corresponding to the collection file 3b. Further, in the format information, it may be defined that the element of the data record is “record”, and child elements thereof are” element1”, “element2”, and “element1”, and child elements thereof are a plurality of “element11”s. Further, in the collection file 3b, it is assumed that the collection source component defines an element value in “element2” to be separated by a delimiter character “$” in a unique specification. For example, the first record of the collection file 3b indicates that the first record includes item values of “R1”, “ccc”, “d1”, “x1”, “d2”, “x2”, “e11”, and “e1y”.

Returning to FIG. 3, the description will be continued. The operation management system 200 includes a collection apparatus 201, an operation management apparatus 202, and a management terminal 203. Here, it is indicated that the collection apparatus 201 and the operation management apparatus 202 are connected and the operation management apparatus 202 and the management terminal 203 are connected. Note that some or all of the collection apparatus 201, the operation management apparatus 202, and the management terminal 203 may be configured by the same hardware. Alternatively, the collection apparatus 201 and the operation management apparatus 202 may be made redundant by a plurality of computers. Furthermore, a plurality of management terminals 203 may be provided.

The collection apparatus 201 collects a setting file or a log file from each component of the information system 100 via the network N as a collection file at a predetermined timing, and stores the setting file or the log file therein. Alternatively, the collection apparatus 201 may transmit the collection file to the operation management apparatus 202.

The operation management apparatus 202 is an example of the operation management apparatus 1 described above. The operation management apparatus 202 registers the expected value for each item in various collection files in the expected value table based on the format information and the delimiter definition information. In addition, the operation management apparatus 202 registers data for each item from various collection files in the collected data table based on the format information and the delimiter definition information. Then, the operation management apparatus 202 compares data associated with common items in the expected value table and the collected data table for a specific collection file, and outputs a comparison result. Note that the operation management apparatus 202 may be redundant in a plurality of computers, and each functional block may be realized by a plurality of computers.

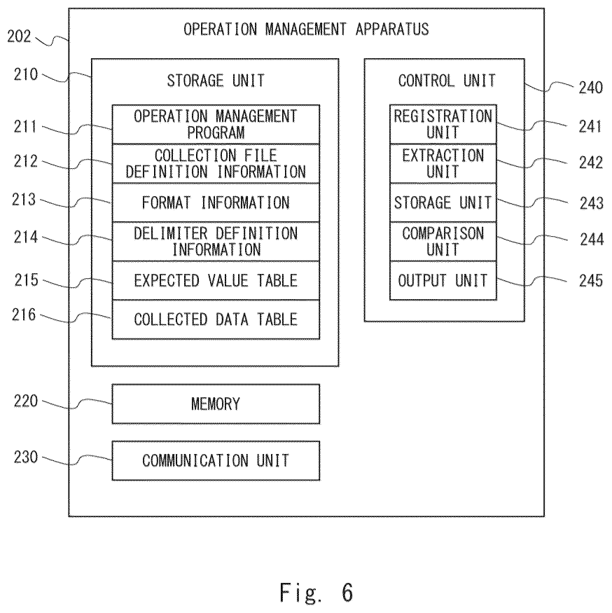

FIG. 6 is a block diagram illustrating a configuration of the operation management apparatus 202 according to the second example embodiment. The operation management apparatus 202 includes a storage unit 210, a memory 220, a communication unit 230, and a control unit 240. The storage unit 210 is an example of a storage device such as a hard disk or a flash memory. The storage unit 210 stores an operation management program 211, collection file definition information 212, format information 213, delimiter definition information 214, an expected value table 215, and a collected data table 216. Some or all of the collection file definition information 212, the format information 213, the delimiter definition information 214, the expected value table 215, and the collected data table 216 may be stored in an external storage device connected to the operation management apparatus 202. The operation management program 211 is a computer program in which the operation management processing and the like according to the second example embodiment are implemented.

The collection file definition information 212 is information defining a file to be collected by the collection apparatus 201. The collection file definition information 212 defines a collection source component of a collection target file, a path (directory name) of a storage destination of the file, a file name, and the like.

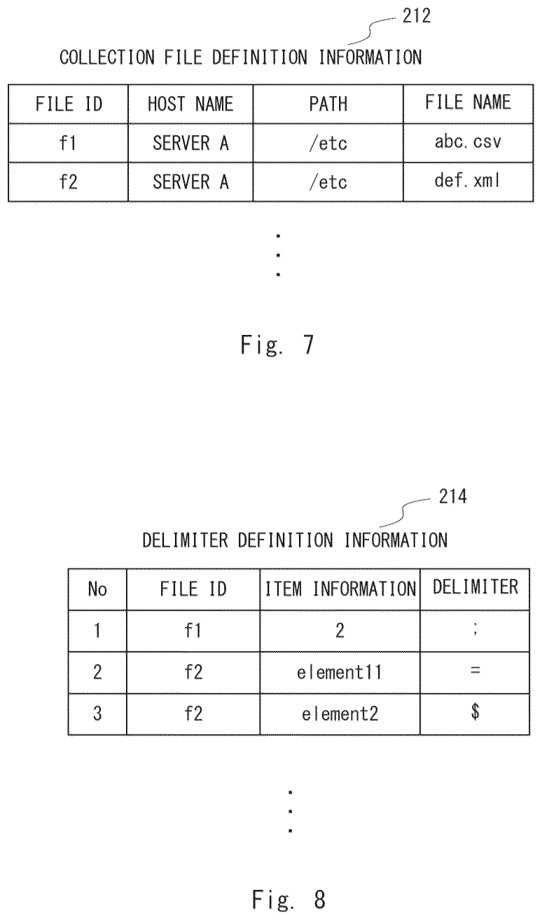

FIG. 7 is a diagram illustrating an example of the collection file definition information 212 according to the second example embodiment. The collection file definition information 212 is information in which a file ID, a host name, a path, and a file name are associated with each other.

Returning to FIG. 6, the description will be continued.

The format information 213 is information defining a format corresponding to the file format of the collection file. The format information 213 may be defined for each file ID of the collection file definition information 212. For example, the format information 213 includes definition information in CSV format, XML format, or the like. Furthermore, in the case of the XML format, various tags may be defined for each collection file.

The delimiter definition information 214 is information defining a delimiter character between items defined for each component of the information system. That is, the delimiter definition information 214 is information that defines how to describe the items uniquely defined by the components, in addition to the definition in the format information 213 described above. Hereinafter, the delimiter character may be referred to as a delimiter or a delimiter character.

FIG. 8 is a diagram illustrating an example of the delimiter definition information 214 according to the second example embodiment. The delimiter definition information 214 is information in which No, a file ID, item information, and a delimiter are associated with each other. Here, the item information is, for example, an order (position information) of elements in one record in the CSV format, and is an element name (tag name) in the XML format. For example, since the file ID “f1” is a CSV file in the format information 213, normally, records and items are separated by line feed characters and comma characters. In addition, in No “1” of the delimiter definition information 214, in the file ID “f1” and the item information “2”, the delimiter “;” is illustrated as a delimiter character between items. In the collection file 3a of FIG. 4 described above, this means that for the second element “aa1; aa2” when separated by a comma character, two item values “aa1” and “aa2” are set with the delimiter “;”.

Furthermore, in the delimiter definition information 214, a plurality of delimiter characters may be defined in a specific component. For example, since the file ID “f2” is an XML file in the format information 213, normally, a record and a value of each item are described based on a definition of a tag. In addition, No “2” of the delimiter definition information 214 indicates that the delimiter “=” is used as a delimiter character between items in the file ID “f2” and the item information “element11”. No “3” in the delimiter definition information 214 indicates that the delimiter “$” is used as a delimiter character between items in the file ID “f2” and the item information “element2”. In the collection file 3b of FIG. 5 described above, in the “element11” of the record R1, the delimiter “=” is set to two item values “d1” and “x1”, and “d2” and “x2”. In addition, in the collection file 3b, it means that two item values “e11” and “e1y” are set with the delimiter “$” in “element2” of the record R1. That is, it is indicated that two types of delimiters are defined in one collection file 3b in addition to the tag definition of normal XML. Note that three or more delimiter characters may be defined in a specific component. As a result, not only the definition (format information) of a general file format but also the same extension or file format can flexibly support the definition of various items. For example, general-purpose format information common to a plurality of collection files can be defined as the format information 213. Then, in a case where a part of the collection file is a unique specification, an item definition of a difference from the format information 213 can be defined in the delimiter definition information 214. Therefore, it is not necessary to correct the data extraction processing for each type of the collection file by preventing overlapping definitions, and the maintenance cost can be reduced.

From the above, it can be said that the item information (item name, order of items, position of element) of the collection file is defined across both the format information 213 and the delimiter definition information 214. However, the delimiter definition information 214 may not be defined in all the collection files defined in the collection file definition information 212. That is, some collection files are not defined in the delimiter definition information 214, and item information may be defined by the format information 213.

Returning to FIG. 6, the description will be continued.

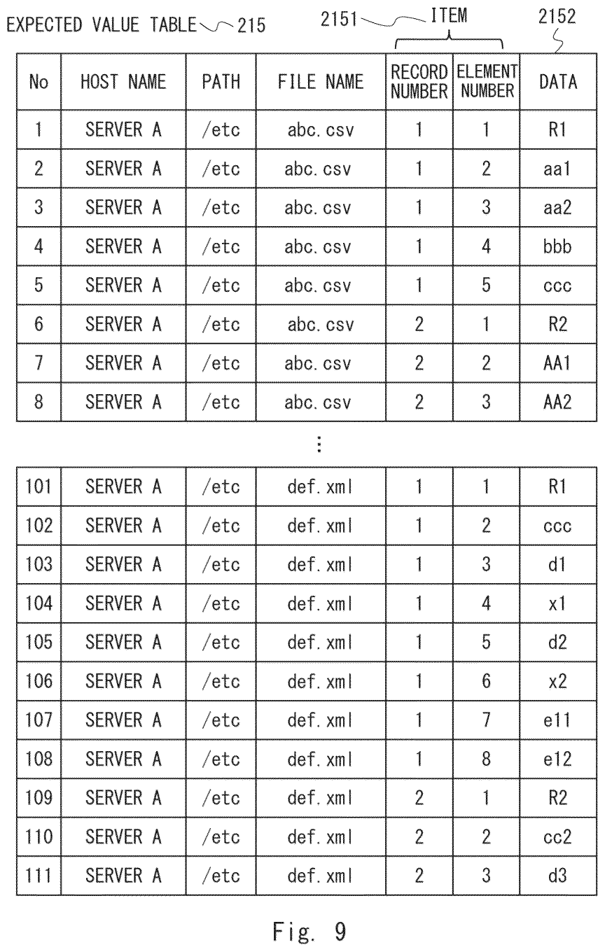

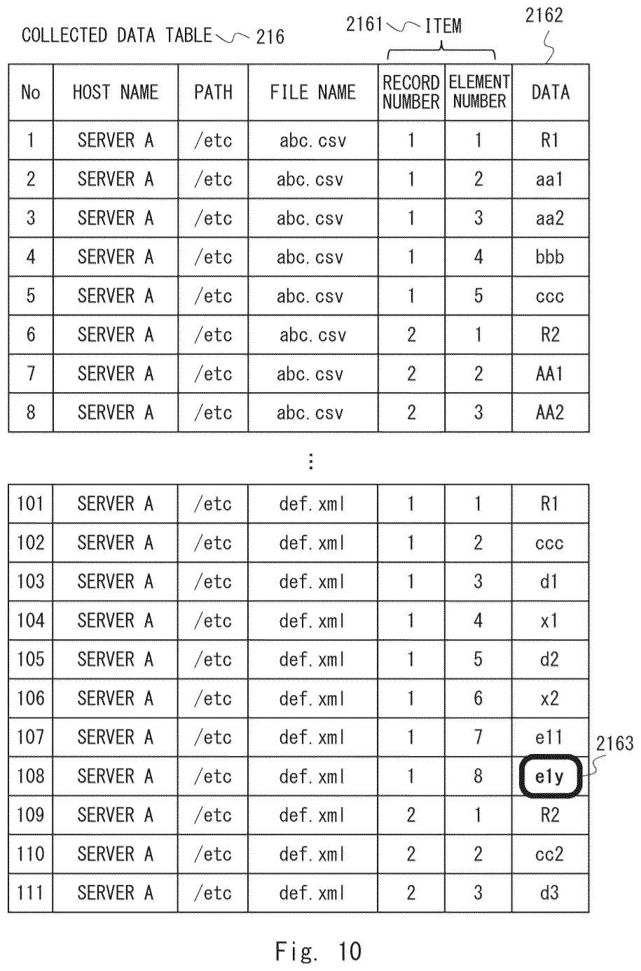

The expected value table 215 is a table storing an expected value to be compared with data for each item in the collection file. FIG. 9 is a diagram illustrating an example of the expected value table 215 according to the second example embodiment. FIG. 9 illustrates an example in which the data 2152 for each item 2151 in each collection file defined in the collection file definition information 212 is stored as an expected value. The item 2151 is a set of a record number and an element number.

Returning to FIG. 6, the description will be continued.

The collected data table 216 is a table in which data (collected data) in each collection file defined in the collection file definition information 212 is stored in association with each item. FIG. 10 is a diagram illustrating an example of the collected data table 216 according to the second example embodiment. FIG. 10 illustrates an example in which the data 2162 for each item 2161 extracted from the collection files 3a and 3b based on the format information 213 and the delimiter definition information 214 is stored. The item 2161 is a set of a record number and an element number. Note that “e1y” of the data 2163 indicates an example different from the data” e12” in the corresponding item (record number “1”, element number “8”) of the expected value table 215.

In FIGS. 9 and 10, the expected value table 215 and the collected data table 216 have the same data structure (attribute name and attribute order), but it is not always necessary to have the same data structure. The expected value table 215 and the collected data table 216 only need to have at least a target collection file, an item (or item name, item information), and an item value as attributes.

Furthermore, in the examples of FIGS. 9 and 10, the element name (R1, ccc, d1, d2, etc.) is included as an item of the XML file, but the invention is not limited thereto. For example, R1 and R2 of the collection file 3b may be record names and values of record numbers. In addition, the name attributes “d1” and “d2” of “element1” of the collection file 3b may be used as item names and element number values. That is, the record number “R1”, the element number “d1”, and the data “x1” may be stored in the expected value table 215 and the collected data table 216.

Returning to FIG. 6, the description will be continued.

The memory 220 is a volatile storage device such as a random access memory (RAM), and is a storage area for temporarily holding information during the operation of the control unit 240. The communication unit 230 is a communication interface between the inside and the outside of the operation management apparatus 202.

The control unit 240 is a processor that controls each component of the operation management apparatus 202, that is, a control apparatus. The control unit 240 reads the operation management program 211 from the storage unit 210 into the memory 220 and executes the operation management program 211. As a result, the control unit 240 implements the functions of a registration unit 241, an extraction unit 242, a storage unit 243, a comparison unit 244, and an output unit 245.

The registration unit 241 acquires the collection file from the collection apparatus 201 based on the collection file definition information 212, and registers the data for each item extracted from the collection file in the expected value table 215 or the collected data table 216 using the extraction unit 242 and the storage unit 243 to be described later. That is, the registration unit 241, the extraction unit 242, and the storage unit 243 perform expected value registration processing and collected data registration processing.

The extraction unit 242 is an example of the extraction unit 11 described above. The extraction unit 242 extracts data for each item from the collection file collected by the collection apparatus 201 based on the format information 213 of the collection file to be processed and the delimiter definition information 214. In particular, the extraction unit 242 extracts record data that is a character string in the record unit from the collection file according to the format information 213, divides the record data by the delimiter defined in the delimiter definition information 214, and extracts the divided character string as data for each item.

The storage unit 243 is an example of the storage unit 12 described above. The storage unit 243 stores the data extracted by the extraction unit 242 and the item in association with each other in the collected data table 216. When acquiring the expected value of each item in the collection file, the storage unit 243 stores the expected value and the item in association with each other in the expected value table 215.

The comparison unit 244 compares data associated with common items in the expected value table 215 and the collected data table 216 for the collection file to be compared.

The output unit 245 outputs the comparison result by the comparison unit 244. For example, the output unit 245 outputs the comparison result to the management terminal 203. Note that the comparison unit 244 and the output unit 245 are examples of the above-described comparison unit 13.

Returning to FIG. 3, the description will be continued. The management terminal 203 is a terminal device operated by an administrator of the operation management system 200, and is, for example, a personal computer or the like. The management terminal 203 is communicably connected to the operation management apparatus 202 via a network or the like, and accesses the operation management apparatus 202 according to an operation of the administrator to input information or the like. Note that the management terminal 203 may also be connected to the collection apparatus 201 and the network N.

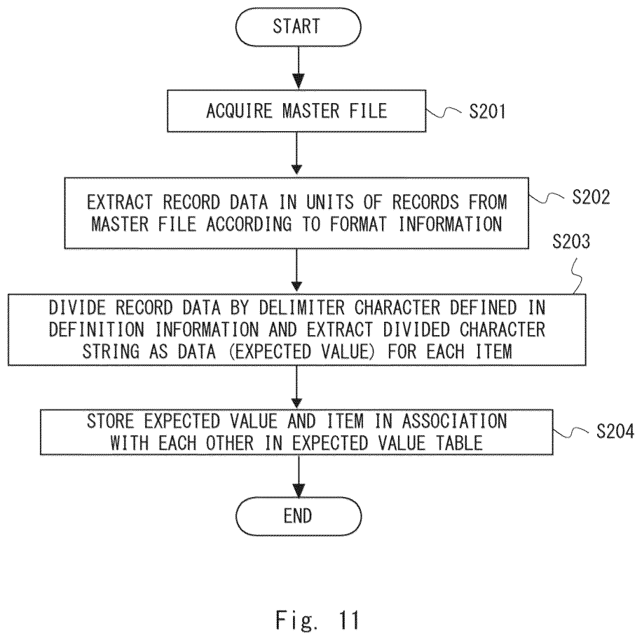

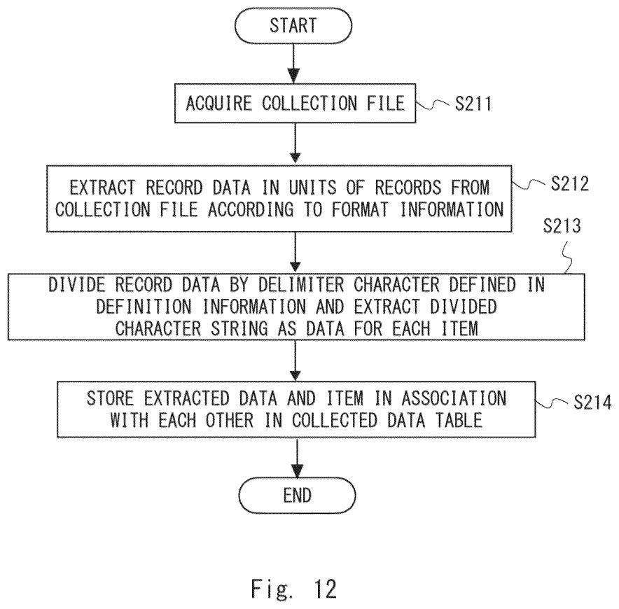

FIG. 11 is a flowchart illustrating a flow of the expected value registration processing according to the second example embodiment. Here, it is assumed that a master file in which an expected value is set to each item of a file of the same format as the collection file is used. For example, a collection file collected at the time of initial setting at the time of constructing an environment of a component in the information system 100 may be used as a master file. Note that, instead of the master file, the administrator may input the expected value of each item via the management terminal 203 and register the expected value in the expected value table 215 of the operation management apparatus 202.

First, the management terminal 203 transmits an expected value registration request including the master file to the operation management apparatus 202 according to an operation of the administrator. At this time, the management terminal 203 may include the file ID of the collection file definition information 212 in the expected value registration request. In response to this, the registration unit 241 of the operation management apparatus 202 acquires the master file from the management terminal 203 (S201).

Next, the extraction unit 242 specifies the file ID included in the expected value registration request, and refers to the collection file definition information 212 to specify the type of the master file acquired in Step S201. Then, the extraction unit 242 extracts record data in units of records from the master file according to the format information 213 (S202). Specifically, the extraction unit 242 analyzes the master file according to the format corresponding to the specified file ID in the format information 213, and extracts the record data.

Then, the extraction unit 242 divides the record data by the delimiter character (delimiter) defined in the delimiter definition information 214, and extracts the divided character string as data (expected value) for each item (S203).

Thereafter, the storage unit 243 stores the expected value and the item in association with each other in the expected value table 215 (S204). As a result, for example, as illustrated in FIG. 9 described above, the expected value is stored in association with the item.

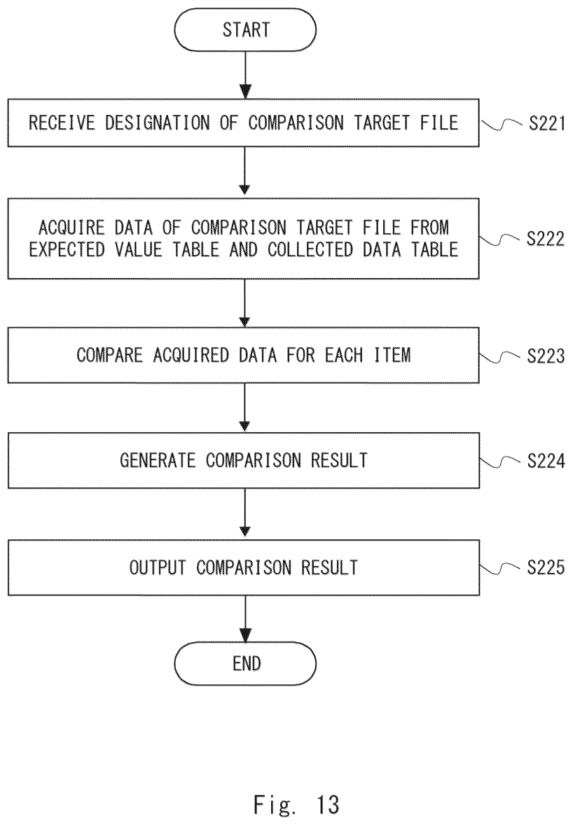

FIG. 12 is a flowchart illustrating a flow of collected data registration processing according to the second example embodiment. As a premise, the collection apparatus 201 assumes that each collection file defined in the collection file definition information 212 has been collected from each component of the information system 100 via the network N. Then, the registration unit 241 of the operation management apparatus 202 acquires the collection file from the collection apparatus 201 (S211). The collection file may include a file ID. Alternatively, the registration unit 241 may specify a set of a file ID, a host name, a path, and a file name for the collection apparatus 201 to acquire the collection file.

Next, similarly to Step S202 described above, the extraction unit 242 extracts record data in units of records from the collection file according to the format information 213 (S212). Then, similarly to Step S203 described above, the extraction unit 242 divides the record data by the delimiter character defined in the delimiter definition information 214, and extracts the divided character string as data for each item (S213).

Thereafter, the storage unit 243 stores the extracted data and items in association with each other in the collected data table 216 (S214). As a result, for example, the collected data is stored in association with the item as illustrated in FIG. 10 described above.

FIG. 13 is a flowchart illustrating a flow of comparison processing according to the second example embodiment. The operation management apparatus 202 continues from FIG. 12 or executes the comparison processing at an arbitrary timing. For example, the management terminal 203 accepts designation of the file ID of the comparison target file by the administrator and transmits the file ID to the operation management apparatus 202. Alternatively, the management terminal 203 accepts designation of the host name, the path, and the file name of the comparison target file by the administrator and transmits them to the operation management apparatus 202. In response to these, the comparison unit 244 of the operation management apparatus 202 receives the designation of the comparison target file (S221). Specifically, the comparison unit 244 refers to the collection file definition information 212 and specifies the comparison target file from the designated file ID. For example, when “f2” is designated as the file ID, the comparison unit 244 specifies the host name “server A”, the path “/etc”, and the file name “def.xml”.

Next, the comparison unit 244 acquires data of the comparison target file from the expected value table 215 and the collected data table 216 (S222). For example, the comparison unit 244 reads items and data of the host name “server A”, the path “/etc”, and the file name “def.xml” of the expected value table 215 and the collected data table 216.

Then, the comparison unit 244 compares the acquired data for each item (S223). For example, the comparison unit 244 compares the expected value “R1” of No “101” in the expected value table 215 with the expected value “R1” of No “101” in the collected data table 216. In addition, the comparison unit 244 compares the expected value “e12” of No “108” in the expected value table 215 with the expected value “e1y” of No “108” in the collected data table 216.

Then, the comparison unit 244 generates a comparison result (S224). Specifically, the comparison unit 244 sets the comparison result to “∘” when the data matches in the comparison in Step S223, and sets the comparison result to “x” when the data does not match. Then, the comparison unit 244 generates screen display data including the comparison result.

Thereafter, the output unit 245 outputs the comparison result to the management terminal 203 (S225). Specifically, the output unit 245 transmits the generated screen display data to the management terminal 203. In response to this, the management terminal 203 displays the received screen display data on the screen.

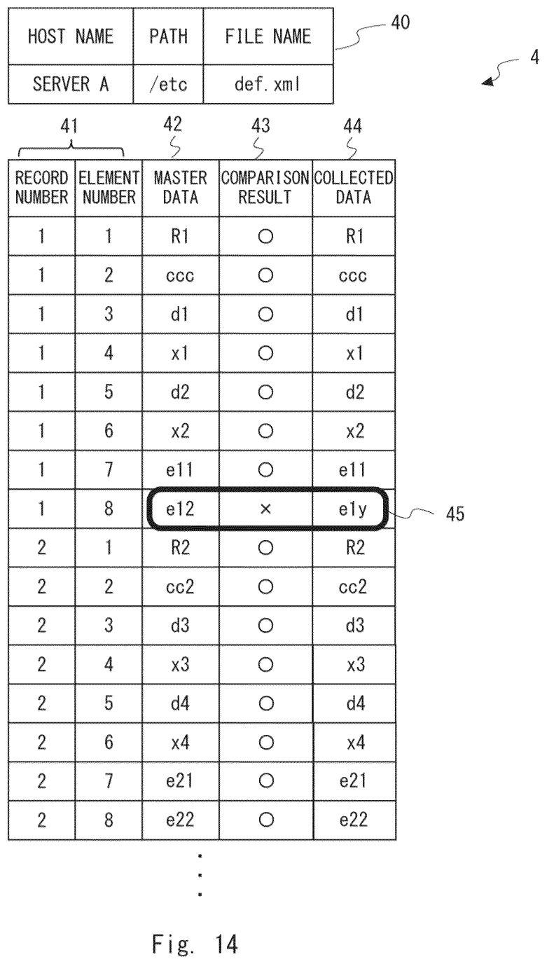

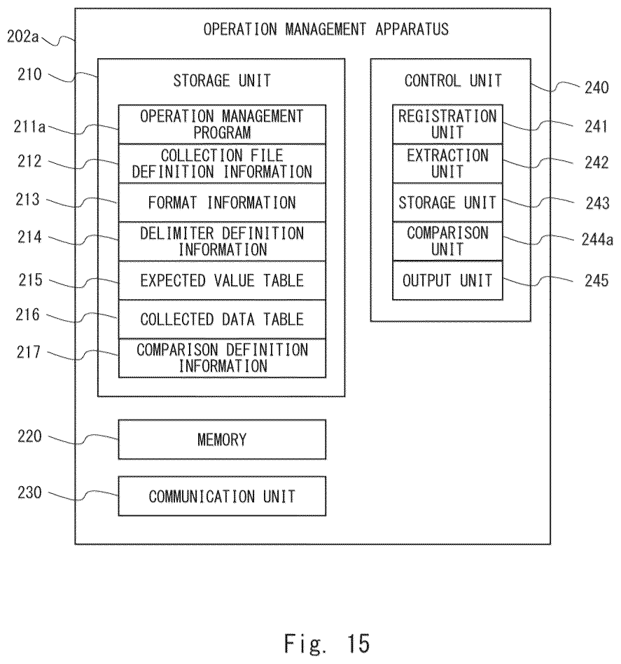

FIG. 14 is a diagram illustrating an example of comparison result information 4 of all items according to the second example embodiment. The comparison result information 4 includes comparison target file information 40, an item 41, a master data 42, a comparison result 43, and collected data 44. The comparison target file information 40 is designated in Step S221 and displays information on the specified comparison target file. The item 41 is a set of a record number and an element number. Here, the items subsequent to No “101” in the expected value table 215 in FIG. 9 and the collected data table 216 in FIG. 10 described above are displayed. The master data 42 is the expected value acquired from the expected value table 215 in Step S222, and the collected data 44 is the data value acquired from the collected data table 216 in Step S222. The comparison result 43 is the comparison result for each item generated in Step S224. In this example, the comparison result 45 indicates that the expected value and the collected data do not match.

As described above, in the present example embodiment, by analyzing the collection file using delimiter definition information 214 in addition to format information 213, data can be appropriately extracted by similar extraction processing even in a wide variety of file formats, particularly, in a manner of setting items specific to components. For example, even in a plurality of XMLs having a common XML schema as an example of the format information 213, a certain application server may separate and interpret item values using a unique delimiter in element values of a defined tag. Meanwhile, even in the setting file of the same XML schema, in the case of the DB server, there is a case where the item values are divided and interpreted using different delimiters for the element values of different tags. In such a case, it is usually necessary to define separate format information or to customize the extraction processing module individually. Meanwhile, according to the present example embodiment, a portion having a common item definition in a plurality of collection files is defined in the format information 213, and a unique portion is defined in the delimiter definition information 214, so that a wide variety of file formats can be flexibly supported. In addition, since a partial format difference is defined by the delimiter definition information 214 and can be handled by the same extraction processing module, the amount to be defined can be reduced, and the complexity of modifying the extraction processing module can be reduced.

In addition, by sharing the data structure between the expected value table 215 and the collected data table 216, the comparison processing can be simplified, and the processing efficiency can be improved. Further, by visualizing the comparison result, the administrator can easily visually recognize the comparison result.

### Third Example Embodiment

A third example embodiment is a modified example of the second example embodiment described above. In the third example embodiment, the comparison processing is made efficient by narrowing down the comparison target items, and the confirmation of the comparison result is facilitated. Note that the overall configuration including the operation management system according to the present example embodiment and the information system to be managed is similar to that in FIG. 3 described above, and description overlapping with the second example embodiment including the other configurations will be appropriately omitted.

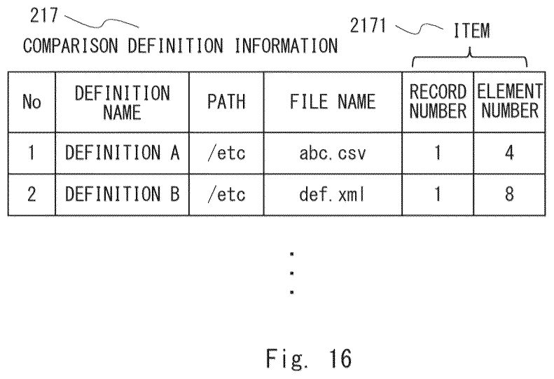

FIG. 15 is a block diagram illustrating a configuration of an operation management apparatus 202a according to the third example embodiment. In the operation management apparatus 202a, as compared with FIG. 6 described above, an operation management program 21la and a comparison unit 244a are replaced, and a comparison definition information 217 is added. Other configurations are equivalent to those of the operation management apparatus 202 described above.

The operation management program 211a is a computer program in which the operation management processing and the like according to the third example embodiment are implemented. The comparison definition information 217 is information defining an item to be subjected to comparison processing for each file. That is, the comparison definition information 217 is used to narrow down items to be compared.

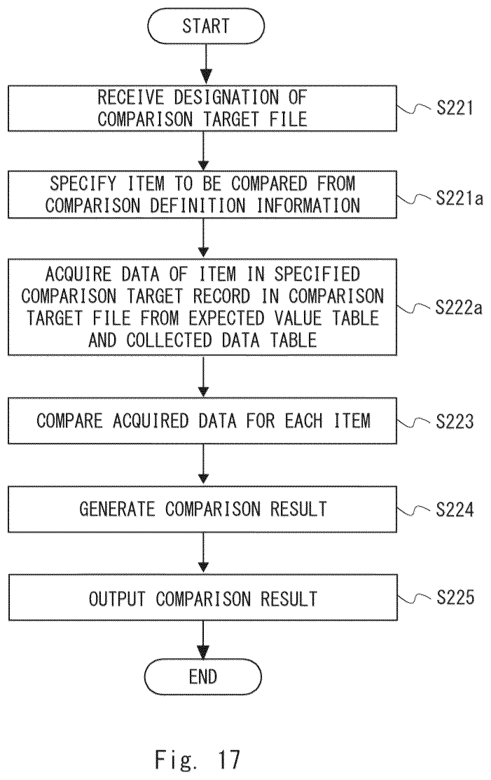

FIG. 16 is a diagram illustrating an example of the comparison definition information 217 according to the third example embodiment. The comparison definition information 217 is information in which No, a definition name, a path, a file name, a record number, and an element number are associated with each other. The record number and the element number are the item 2171. Here, “definition A” indicates that the record number “1” and the element number “4” of “abc.csv” are set as comparison targets, and other items of the file are excluded from comparison targets. Furthermore, “definition B” indicates that the record number “1” and the element number “8” of “def.xml” are set as comparison targets, and other items of the same file are excluded from comparison targets. Note that FIG. 16 is merely an example.

Returning to FIG. 15, the description will continue. The comparison unit 244a compares the data associated with the designated item among the items of the collection file in the expected value table 215 and the collected data table 216 to obtain a comparison result.

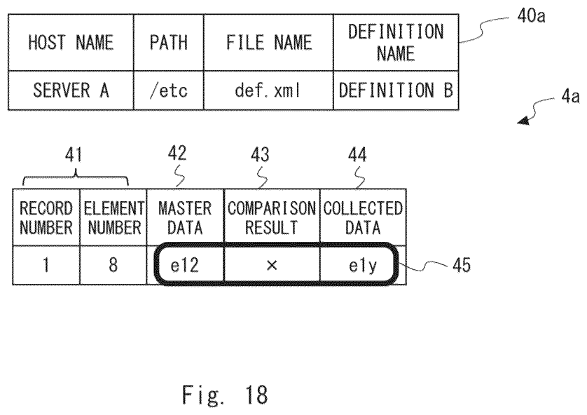

FIG. 17 is a flowchart illustrating a flow of comparison processing according to the third example embodiment. In FIG. 17, as compared with FIG. 13 described above, Step S221a is added after Step S221, and Step S222 is replaced with Step S222a. Differences from FIG. 13 will be mainly described below.

After Step S221, the comparison unit 244a specifies an item to be compared from the comparison definition information 217 (S221a). For example, when “f2” is designated as the file ID, the comparison unit 244a specifies the record number “1” and the element number “8” of “def.xml” in “definition B” in the comparison definition information 217 as comparison targets.

Then, the comparison unit 244a acquires data of an item in the specified record in the specified comparison target file from the expected value table 215 and the collected data table 216 (S222a). For example, the comparison unit 244a acquires the expected value “e12” from the expected value table 215 and the collected data “e1y” from the collected data table 216.

Then, the comparison unit 244a compares the acquired data for each item (S223). For example, the comparison unit 244a determines whether the expected value “e12” and the collected data “e1y” match. Then, the comparison unit 244a generates a comparison result (S224). Here, the comparison unit 244a sets the comparison result to “x”. Then, the comparison unit 244a generates screen display data including the expected value “e12”, the collected data “e1y”, and the comparison result “x”.

Thereafter, the output unit 245 outputs the comparison result to the management terminal 203 (S225). FIG. 18 is a diagram illustrating an example of comparison result information 4a of the designated item according to the third example embodiment. The comparison result information 4a includes comparison target definition information 40a, an item 41, master data 42, a comparison result 43, and collected data 44. The comparison target definition information 40a displays information about the comparison target file specified in Step S221a and definition thereof. The collected data 44 is narrowed down to the comparison result 45 from the item 41 as compared with FIG. 14 described above.

In the second example embodiment described above, the comparison result between the expected value and the collected data is displayed for all the items of the comparison target file. However, the administrator often grasps an item having a high importance level to be compared by daily monitoring. In addition, the comparison results of all the items are large in quantity, and there is a risk of overlooking the comparison results of the items with high importance. Therefore, in the present example embodiment, by setting the comparison definition information 217 in advance, the comparison target items are narrowed down at the time of comparison processing. As a result, it is possible to improve the efficiency of the comparison processing, facilitate confirmation of the comparison result by the administrator, and in particular, it is possible to efficiently detect inconsistency of items with high importance.

In the comparison processing, the operation management apparatus 202 may receive selection of all the comparison items or an item set in the comparison definition information 217 from the management terminal 203 and execute the comparison processing according to the selection. Further, the comparison definition information 217 may set a plurality of types of definition information for the same collection file. As a result, the comparison target item can be easily switched according to the situation.

### Fourth Example Embodiment

The fourth example embodiment is a modified example of the second or third example embodiment described above. In the second example embodiment described above, an example in which the master file is collected from the same component as the collection file has been described. Meanwhile, in the fourth example embodiment, a collection file of another component having a large degree of commonality in setting contents is used as an expected value. For example, in a case where the second server is constructed in order to make the first server redundant in a state where the first server in the information system has been constructed, there is a lot of commonality in setting contents. In this case, the setting value of the collection file of the first server is used as the expected value of the collection file of the second server. As a result, it is possible to efficiently confirm the difference by comparing the plurality of servers side by side. Note that the overall configuration including the operation management system according to the present example embodiment and the information system to be managed is similar to that in FIG. 3 described above, and description overlapping with the second example embodiment including the other configurations will be appropriately omitted.

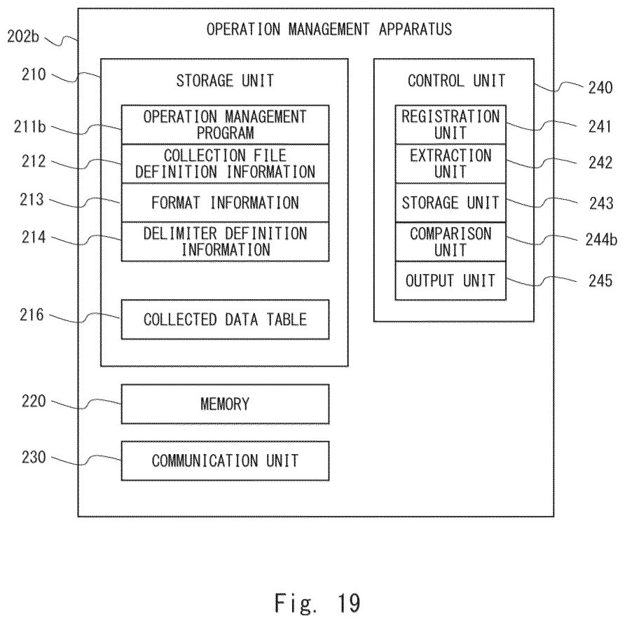

FIG. 19 is a block diagram illustrating a configuration of an operation management apparatus 202b according to the fourth example embodiment. In the operation management apparatus 202b, as compared with FIG. 6 described above, the operation management program 211b and the comparison unit 244b are replaced, and the expected value table 215 is deleted. Other configurations are equivalent to those of the operation management apparatus 202 described above.

The operation management program 211b is a computer program in which the operation management processing and the like according to the fourth example embodiment are implemented. The collected data table 216 includes a first collected data table and a second collected data table. Here, the first collected data table is a table that stores data extracted from the first collection file collected from the first server among the components of the information system. Then, the first collected data table is used as a table corresponding to the above-described expected value table 215. The second collected data table is a table in which data extracted from the second collection file collected from the second server among the components of the information system is stored.

The comparison unit 244b compares data associated with common items in the first collected data table and the second collected data table.

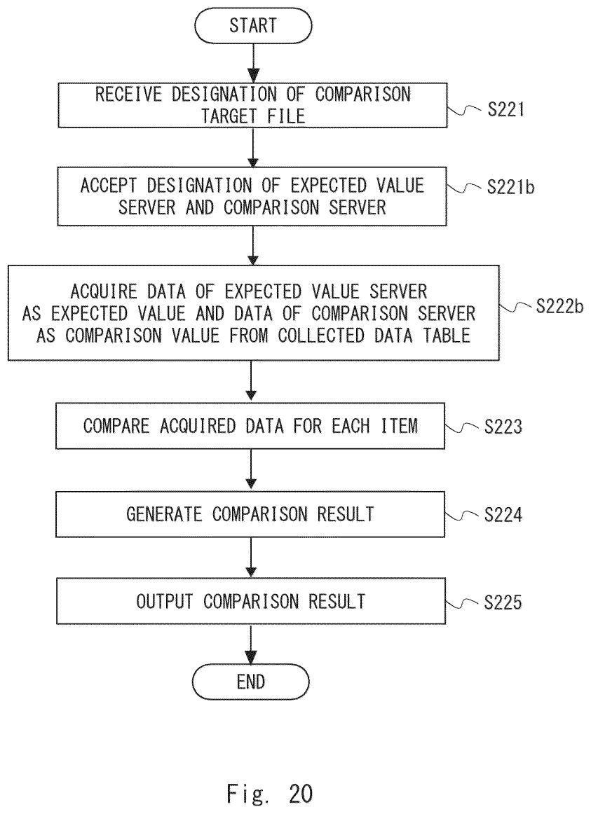

FIG. 20 is a flowchart illustrating a flow of comparison processing according to the fourth example embodiment. In FIG. 20, as compared with FIG. 13 described above, Step S221b is added after Step S221, and Step S222 is replaced with Step S222b. Differences from FIG. 13 will be mainly described below.

After Step S221, the comparison unit 244b accepts designation of the expected value server and the comparison server (S221b). For example, the comparison unit 244b accepts designation of the first server as the expected value server and the second server as a comparison server.

Then, the comparison unit 244b acquires each piece of data of the comparison target file from the collected data table 216 (S222b). At this time, the comparison unit 244b acquires data of the expected value server from the collected data table 216 as an expected value. In addition, the comparison unit 244b acquires data of the comparison server from the collected data table 216 as a comparison value.

Then, the comparison unit 244b compares the acquired data for each item (S223). Specifically, the comparison unit 244b compares the acquired expected value with the comparison value for each item. Thereafter, the operation management apparatus 202b performs Steps S224 and S225 similarly to FIG. 13 described above.

As described above, the fourth example embodiment can also achieve the same effects as those of the second example embodiment described above. Furthermore, in a case where there is a lot of commonality in setting contents among a plurality of components such as a case where the components are redundant, it is possible to compare the components side by side, and it is possible to efficiently confirm the difference. Note that the fourth example embodiment is also applicable to the third example embodiment described above.

### Other Example Embodiments

In the above-described example, the program includes a group of instructions (or software code) for causing a computer to perform one or more functions described in the example embodiments when being read by the computer. The program may be stored in a non-transitory computer-readable medium or a tangible storage medium. By way of example, and not limitation, the computer-readable medium or tangible storage medium includes random-access memory (RAM), read-only memory (ROM), flash memory, solid-state drive (SSD) or other memory technology, CD-ROM, digital versatile disc (DVD), Blu-ray® disc or other optical disk storage, magnetic cassettes, magnetic tape, magnetic disk storage, or other magnetic storage devices. The program may be transmitted on a transitory computer-readable medium or a communication medium. By way of example, and not limitation, the transitory computer-readable medium or communication medium includes electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### Supplementary Note A1

An operation management apparatus including:
an extraction means for extracting data for each item from a collection file based on format information of the collection file collected from a component of an information system and definition information of a delimiter character between items defined by the component;
a storage means for storing the extracted data and the item in association with each other in a collected data table; and
a comparison means for comparing data associated with a common item in an expected value table storing an expected value of each item in the collection file and the collected data table and outputting a comparison result.

### Supplementary Note A2

The operation management apparatus according to Supplementary Note A1, in which the extraction means
extracts record data that is a character string of a record unit from the collection file according to the format information, and
divides the record data by the delimiter character defined in the definition information and extracts the divided character string as data for each of the items.

### Supplementary Note A3

The operation management apparatus according to Supplementary Note A1 or A2, in which the comparison means
compares data associated with a designated item among items of the collection file in the expected value table and the collected data table to obtain the comparison result.

### Supplementary Note A4

The operation management apparatus according to any one of Supplementary Notes A1 to A3, in which in the definition information, a plurality of delimiter characters are defined in a specific component.

### Supplementary Note A5

The operation management apparatus according to any one of Supplementary Notes A1 to A4, in which
the expected value table is a first collected data table storing data extracted from a first collection file collected from a first server among the components of the information system,
the storage means stores data extracted from a second collection file collected from a second server among the components of the information system in a second collected data table, and
the comparison means compares data associated with items common in the first collected data table and the second collected data table, and outputs the comparison of the data as the comparison result.

### Supplementary Note A6

The operation management apparatus according to any one of Supplementary Notes A1 to A4, in which when acquiring an expected value of each item in the collection file, the storage means stores the expected value and the item in association with each other in the expected value table.

### Supplementary Note B1

An operation management system including:
a collection apparatus configured to collect a collection file from a component of an information system; and
an operation management apparatus connected to the collection apparatus,
in which the operation management apparatus includes
an extraction means for extracting data for each item from the collection file collected by the collection apparatus based on format information of the collection file and definition information of a delimiter character between items defined by the component,
a storage means for storing the extracted data and the item in association with each other in a collected data table, and
a comparison means for comparing data associated with a common item in an expected value table storing an expected value of each item in the collection file and the collected data table and outputting a comparison result.

### Supplementary Note B2

The operation management system according to Supplementary Note B1, in which the extraction means
extracts record data that is a character string of a record unit from the collection file according to the format information, and
divides the record data by the delimiter character defined in the definition information and extracts the divided character string as data for each of the items.

### Supplementary Note C1

An operation management method performed by a computer, the method including:
extracting data for each item from a collection file based on format information of the collection file collected from a component of an information system and definition information of a delimiter character between items defined by the component;
storing the extracted data and the item in association with each other in a collected data table; and
comparing data associated with a common item in an expected value table storing an expected value of each item in the collection file and the collected data table and outputting a comparison result.

### Supplementary Note D1

A non-transitory computer-readable medium storing an operation management program for causing a computer to execute:
extraction processing of extracting data for each item from a collection file based on format information of the collection file collected from a component of an information system and definition information of a delimiter character between items defined by the component;
storage processing of storing the extracted data and the item in association with each other in a collected data table; and
comparison processing of comparing data associated with a common item in an expected value table storing an expected value of each item in the collection file and the collected data table and outputting a comparison result.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### REFERENCE SIGNS LIST

1 Operation Management Apparatus
11 Extraction Unit
12 Storage Unit
13 Comparison Unit
100 Information System
101 NW Device
111 Server
112 Server
11n Server
121 Storage Device
12m Storage Device
N Network
200 Operation Management System
201 Collection Apparatus
202 Operation Management Apparatus
203 Management Terminal
3a Collection File
3b Collection File
210 Storage Unit
211 Operation Management Program
212 Collection File Definition Information
213 Format Information
214 Delimiter Definition Information
215 Expected Value Table
2151 Item
2152 Data
216 Collected Data Table
2161 Item
2162 Data
2163 Data
220 Memory
230 Communication Unit
240 Control Unit
241 Registration Unit
242 Extraction Unit
243 Storage Unit
244 Comparison Unit
245 Output Unit
4 Comparison Result Information
40 Comparison Target File Information
41 Item
42 Master Data
43 Comparison Result
44 Collected Data
202a Operation Management Apparatus
211a Operation Management Program
217 Comparison Definition Information
217l Item
244a Comparison Unit
4a Comparison Result Information
40a Comparison Target Definition Information
45 Comparison Result
202b Operation Management Apparatus
211b Operation Management Program
244b Comparison Unit

What is claimed is:

1. An operation management apparatus comprising:
at least one storage device configured to store instructions; and
at least one processor configured to execute the instructions to:
extract data for each item from a collection file based on format information of the collection file collected from a component of an information system and definition information of a delimiter character between items defined by the component;
store, in the at least one storage device, the extracted data and the item in association with each other in a collected data table; and
compare data associated with a common item in an expected value table storing an expected value of each item in the collection file and the collected data table and output a comparison result.

2. The operation management apparatus according to claim 1, wherein the at least one processor is further configured to execute the instructions to:
extract record data that is a character string of a record unit from the collection file according to the format information, and
divide the record data by the delimiter character defined in the definition information and extracts the divided character string as data for each of the items.

3. The operation management apparatus according to claim 1, wherein the at least one processor is further configured to execute the instructions to:
compare data associated with a designated item among items of the collection file in the expected value table and the collected data table to obtain the comparison result.

4. The operation management apparatus according to claim 1, wherein in the definition information, a plurality of delimiter characters are defined in a specific component.

5. The operation management apparatus according to claim 1, wherein
the expected value table is a first collected data table storing data extracted from a first collection file collected from a first server among the components of the information system, and
wherein the at least one processor is further configured to execute the instructions to:
store, in the at least one storage device, data extracted from a second collection file collected from a second server among the components of the information system in a second collected data table, and
compare data associated with items common in the first collected data table and the second collected data table, and output the comparison of the data as the comparison result.

6. The operation management apparatus according to claim 1,
wherein the at least one processor is further configured to execute the instructions to:
store, in the at least one storage device, the expected value and the item in association with each other in the expected value table, when the operation management apparatus acquires an expected value of each item in the collection file.

7-8. (canceled)

9. An operation management method performed by a computer, the method comprising:
extracting data for each item from a collection file based on format information of the collection file collected from a component of an information system and definition information of a delimiter character between items defined by the component;
storing the extracted data and the item in association with each other in a collected data table; and
comparing data associated with a common item in an expected value table storing an expected value of each item in the collection file and the collected data table and outputting a comparison result.

10. A non-transitory computer-readable medium storing an operation management program for causing a computer to execute:
extraction processing of extracting data for each item from a collection file based on format information of the collection file collected from a component of an information system and definition information of a delimiter character between items defined by the component;
storage processing of storing the extracted data and the item in association with each other in a collected data table; and
comparison processing of comparing data associated with a common item in an expected value table storing an expected value of each item in the collection file and the collected data table and outputting a comparison result.
